(19) United States
(12) Patent Application Publication
(10) Pub. No.: US 2017/0194000 A1
(43) Pub. Date: Jul. 6, 2017

(54) SPEECH RECOGNITION DEVICE AND SPEECH RECOGNITION METHOD

(71) Applicant: MITSUBISHI ELECTRIC CORPORATION, Tokyo (JP)

(72) Inventors: Yusuke ITANI, Tokyo (JP); Isamu OGAWA, Tokyo (JP)

(73) Assignee: MITSUBISHI ELECTRIC CORPORATION, Tokyo (JP)

(21) Appl. No.: 15/315,201

(22) PCT Filed: Jul. 17, 2015
(86) PCT No.: PCT/JP2015/070490

§ 371 Date: Nov. 30, 2016

(30) Foreign Application Priority Data
Jul. 23, 2014 (JP) 2014-149739

(51) Int. Cl. G10L 15/26; G10L 25/72; G07C 9/00; G10L 17/00; G10L 19/008; G10L 15/32; G10L 15/30; G10L 15/28; G10L 15/34

(52) U.S. Cl. CPC G10L 15/26; G10L 15/285; G10L 25/72; G07C 9/00071; G10L 15/34; G10L 19/008; G10L 15/32; G10L 15/30; G10L 17/005

(57) ABSTRACT

A speech recognition device: transmits an input voice to a server; receives a first speech recognition result that is a result from speech recognition by the server on the transmitted input voice; performs speech recognition on the input voice to obtain a second speech recognition result; refers to speech rules each representing a formation of speech elements for the input voice, to determine the speech rule matched to the second speech recognition result; determines from the correspondence relationships among presence/absence of the first speech recognition result, presence/absence of the second speech recognition result and presence/absence of the speech element that forms the speech rule, a speech recognition state indicating the speech element whose speech recognition result is not obtained; generates according to the determined speech recognition state, a response text for inquiring about the speech element whose speech recognition result is not obtained; and outputs that text.

### TECHNICAL FIELD

The present invention relates to a speech recognition device and a speech recognition method for performing recognition processing on spoken voice data.

### BACKGROUND ART

In a conventional speech recognition device in which speech recognition is performed by a client and a server, as disclosed for example in Patent Literature 1, speech recognition is initially performed by the client and, when the recognition score of a client's speech recognition result is low and determined to be poor in recognition accuracy, speech recognition is performed by the server and the server's recognition result is employed.

Further, Patent Literature 1 also discloses a method in which speech recognition by the client and speech recognition by the server are performed simultaneously in parallel, and the recognition score of the client's speech recognition result and the recognition score of the server's speech recognition result are compared to each other, so that one of the speech recognition results whose recognition score is better than the other is employed as the result of recognition.

Meanwhile, as another conventional example in which speech recognition is performed by both a client and a server, Patent Literature 2 discloses a method in which the server transmits, in addition to its speech recognition result, information of parts of speech such as a general noun and a postpositional particle to the client, and the client performs correction in its speech recognition result using the parts-of-speech information received by the client, for example, by replacing a general noun with a proper noun.

### CITATION LIST

### Patent Literature

Patent Literature 1: Japanese Patent Application Laid-open No. 2009-237439

Patent Literature 2: Japanese Patent No. 4902617

### SUMMARY OF THE INVENTION

### Technical Problem

According to the conventional speech recognition device of a server-client type, when no speech recognition result is returned from one of the server and the client, it is unable to notify the user of any speech recognition or, if it is able, the user is notified of only the one-sided result. In this case, the speech recognition device can prompt the user to speak again; however, according to the conventional speech recognition device, the user has to speak from the beginning, and thus, there is a problem that the user bears a heavy burden.

This invention has been made to solve the problem as described above, and an object thereof is to provide a speech recognition device which can prompt the user to re-speak a part of the speech so that the burden on the user is reduced, when no speech recognition result is returned from one of the server and the client.

### Solution to Problem

In order to solve the problem described above, a speech recognition device of the invention comprises: a transmitter that transmits an input voice to a server; a receiver that receives a first speech recognition result that is a result from speech recognition by the server on the input voice transmitted by the transmitter; a speech recognizer that performs speech recognition on the input voice to thereby obtain a second speech recognition result; a speech-rule storage in which speech rules each representing a formation of speech elements for the input voice are stored; a speech-rule determination processor that refers to one or more of the speech rules to thereby determine the speech rule matched to the second speech recognition result; a state determination processor that is storing correspondence relationships among presence/absence of the first speech recognition result, presence/absence of the second speech recognition result and presence/absence of the speech element that forms the speech rule, and that determines from the correspondence relationships, a speech recognition state indicating at least one of the speech elements whose speech recognition result is not obtained; a response text generator that generates according to the speech recognition state determined by the state determination processor, a response text for inquiring about at least the one of the speech elements whose speech recognition result is not obtained; and an outputter that outputs the response text.

### Advantageous Effects of Invention

According to the invention, such an effect is accomplished that, even when no speech recognition result is provided from one of the server and the client, it is possible to reduce the burden on the user by determining the part whose speech recognition result is not obtained and by causing the user to speak that part again.

### BRIEF DESCRIPTION OF DRAWINGS

FIG. 1 is a configuration diagram showing a configuration example of a speech recognition system using a speech recognition device according to Embodiment 1 of the invention.

FIG. 2 is a flowchart (former part) showing a processing flow of the speech recognition device according to Embodiment 1 of the invention.

FIG. 3 is a flowchart (latter part) showing the processing flow of the speech recognition device according to Embodiment 1 of the invention.

FIG. 4 is an example of speech rules stored in a speech-rule storage of the speech recognition device according to Embodiment 1 of the invention.

FIG. 5 is an illustration diagram illustrating unification of a server's speech recognition result and a client's speech recognition result.

FIG. 6 is a diagram showing correspondence relationships among a speech recognition state, presence/absence of the client's speech recognition result, presence/absence of the server's speech recognition result and the speech rule.

FIG. 7 is a diagram showing a relationship between a speech recognition state and a response text to be generated.

FIG. 8 is a diagram showing a correspondence relationship between an ascertained state of speech elements in a speech rule and a speech recognition state.

### DESCRIPTION OF EMBODIMENTS

### Embodiment 1

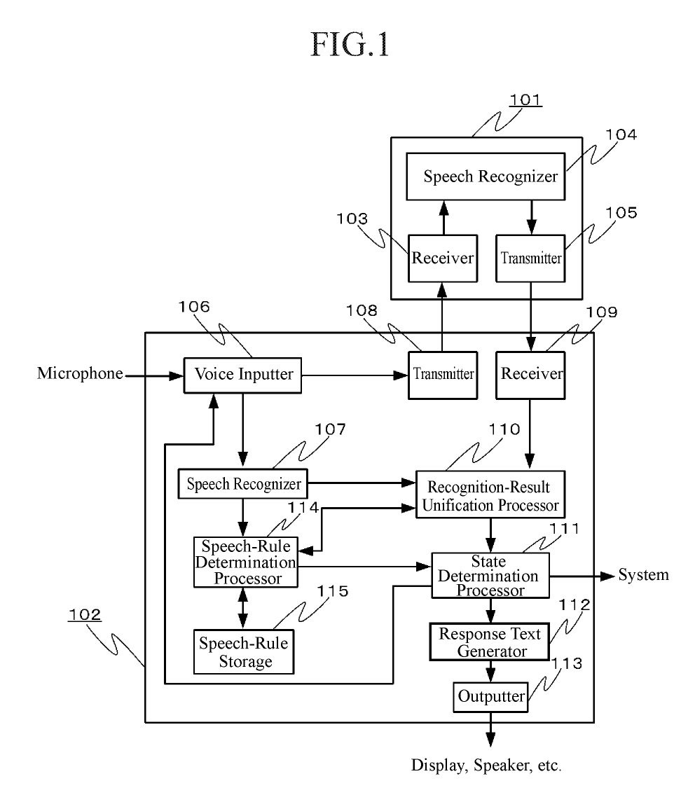

FIG. 1 is a configuration diagram showing a configuration example of a speech recognition system using a speech recognition device according to Embodiment 1 of the invention.

The speech recognition system is configured with a speech recognition server 101 and a speech recognition device 102 of a client.

The speech recognition server 101 includes a transmitter 103, a speech recognizer 104 and a transmitter 105.

The transmitter 103 receives voice data from the speech recognition device 102. The speech recognizer 104 of the server phonetically recognizes the received voice data to thereby output a first speech recognition result. The transmitter 105 transmits to the speech recognition device 102, the first speech recognition result outputted from the speech recognizer 104.

Meanwhile, the speech recognition device 102 of the client includes a voice inputter 106, a speech recognizer 107, a transmitter 108, a receiver 109, a recognition-result unification processor 110, a state determination processor 111, a response text generator 112, an outputter 113, a speech-rule determination processor 114 and a speech-rule storage 115.

The voice inputter 106 is a device that has a microphone or the like, and that converts a voice spoken by a user into data signals, so-called voice data. Note that, as the voice data, PCM (Pulse Code Modulation) data obtained by digitizing the voice signals acquired by a sound pickup device, or the like may be used. The speech recognizer 107 phonetically recognizes the voice data inputted from the voice inputter 106 to thereby output a second speech recognition result. The speech recognition device 102 is configured, for example, with a microprocessor or a DSP (Digital Signal Processor). The speech recognizer 102 may have functions of the speech-rule determination processor 114, the recognition-result unification processor 110, the state determination processor 111, the response text generator 112 and the like. The transmitter 108 is a transmission device for transmitting the inputted voice data to the speech recognition server 101. The receiver 109 is a reception device for receiving the first speech recognition result transmitted from the transmitter 105 of the speech recognition server 101. As the transmitter 108 and the receiver 109, a wireless transceiver or a wired transceiver may be used, for example. The speech-rule determination processor 114 extracts a keyword from the second speech recognition result outputted by the speech recognizer 107, to thereby determine a speech rule of the input voice. The speech-rule storage 115 is a database in which patterns of speech rules for the input voice are stored.

The recognition-result unification processor 110 performs unification about the speech recognition results that is described later, using the speech rule determined by the speech-rule determination processor 114, the first speech recognition result (if present) that the receiver 109 has received from the speech recognition serve 101, and the second speech recognition result (if present) from the speech recognizer 107. Then, the recognition-result unification processor 110 outputs a unified result about the speech recognition results. The unified result includes information of the presence/absence of the first speech recognition result and the presence/absence of the second speech recognition result.

The state determination processor 111 judges whether a command for the system can be ascertained or not, on the basis of the information of the presence/absence of the client's and server's speech recognition results that is included in the unified result outputted from the recognition-result unification processor 110. When a command for the system is not ascertained, the state determination processor 111 determines a speech recognition state to which the unified result corresponds. Then, the state determination processor 111 outputs the determined speech recognition state to the response text generator 112. Meanwhile, when the command for the system is ascertained, the state determination processor outputs the ascertained command to the system.

The response text generator 112 generates a response text corresponding to the speech recognition state outputted by the state determination processor 111, and outputs the response text to the outputter 113. The outputter 113 is a display driver for outputting the inputted response text to a display or the like, and/or a speaker or an interface device for outputting the response text as a voice.

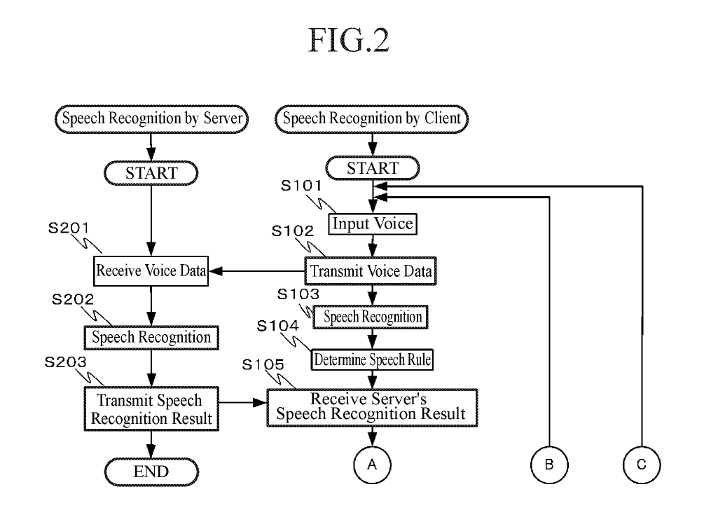

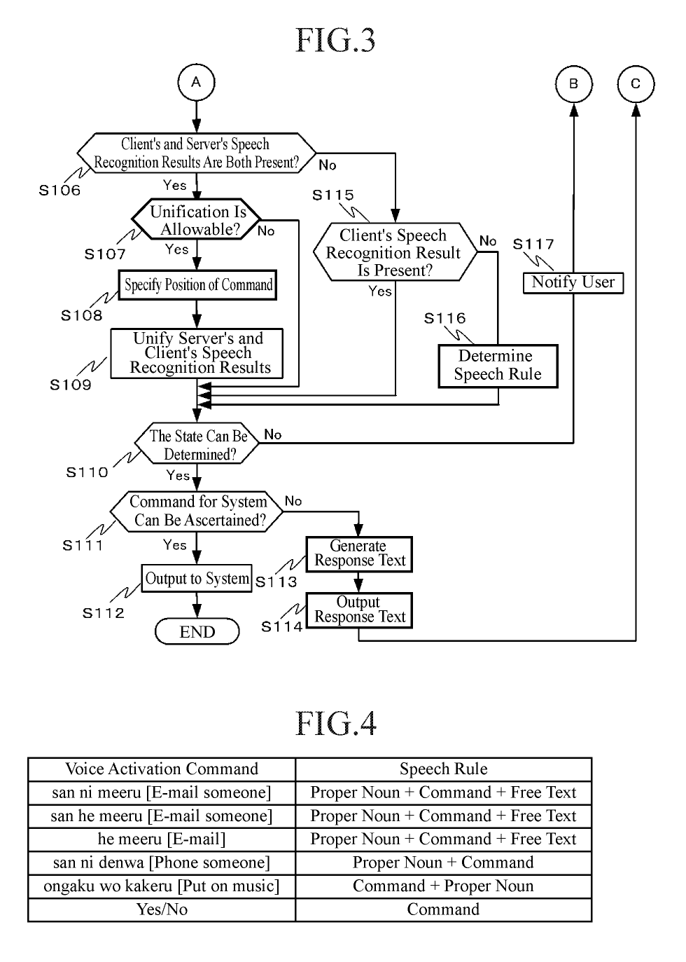

Next, operations of the speech recognition device 102 according to Embodiment 1 will be described with reference to FIG. 2 and FIG. 3.

FIG. 2 and FIG. 3 are a flowchart showing the processing flow of the speech recognition device according to Embodiment 1.

First, in Step S101, using a microphone or the like, the voice inputter 106 converts the voice spoken by the user into the voice data and thereafter, outputs the voice data to the speech recognizer 107 and the transmitter 108.

Then, in Step S102, the transmitter 108 transmits the voice data inputted from the voice inputter 106 to the speech recognition server 101.

The following Step S201 to Step S203 are for the processing by the speech recognition server 101.

First, in Step S201, when the receiver 103 receives the voice data transmitted from the speech recognition device 102 of the client, the speech recognition server 101 outputs the received voice data to the speech recognizer 104 of the server.

Then, in Step S202, with respect to the voice data inputted from the receiver 103, the speech recognizer 104 of the server performs free-text speech recognition, the recognition target of which is an arbitrary sentence, and outputs text information that is a recognition result obtained as the result of that recognition, to the transmitter 105. The method of free-text speech recognition uses, for example, a dictation technique by N-gram continuous speech recognition. Specifically, the speech recognizer 104 of the server performs speech recognition on the voice data of “Kenji san ni meeru, ima kara kaeru” [this means “E-mail Mr. Kenji, I am going back from now”] received from the speech recognition device 102 of the client, and thereafter, outputs a speech-recognition result list in which, for example, “Kenji san ni meiru, ima kara kaeru” [this means “I feel down about the public prosecutor, I am going back from now”] is included as a speech-recognition-result candidate. Note that, as shown in this speech-recognition-result candidate, when a personal name, a command name or the like is included in the voice data, because its speech recognition is difficult, there are cases where the server's speech recognition result includes a recognition error.

Lastly, in Step S203, the transmitter 105 transmits the speech recognition result outputted by the server speech recognizer 104, as the first speech recognition result, to the client speech recognition device 102, so that the processing is terminated.

Next, description will return to the operations of the speech recognition device 102.

In Step S103, with respect to the voice data inputted from the voice inputter 106, the speech recognizer 107 of the client performs speech recognition for recognizing a keyword such as a voice activation command or a personal name, and outputs text information of a recognition result obtained as the result of that recognition, to the recognition-result unification processor 110, as the second speech recognition result. As the speech recognition method for the keyword, for example, a phrase spotting technique is used that extracts a phrase including a postpositional particle as well. The speech recognizer 107 of the client is storing a recognition dictionary in which voice activation commands and information of personal names are registered and listed. The recognition target of the speech recognizer 107 is a voice activation command and information of a personal name that are difficult to be recognized using a large-vocabulary recognition dictionary included in the server. When the user inputs the voice of “Kenji san ni meeru, ima kara kaeru” [“E-mail Mr. Kenji, I am going back from now”], , the speech recognizer 107 recognizes “E-mail” as a voice activation command and “Kenji” as information of a personal name, to thereby outputs a speech recognition result including “E-mail Mr. Kenji” as a speech-recognition-result candidate.

Then, in Step S104, the speech-rule determination processor 114 collates the speech recognition result inputted from the speech recognizer 107 with the speech rules stored in the speech-rule storage 115, to thereby determine the speech rule matched to the speech recognition result.

FIG. 4 is an example of the speech rules stored in the speech-rule storage 115 of the speech recognition device 102 according to Embodiment 1 of the invention.

In FIG. 4, the speech rules corresponding to the voice activation commands are shown. The speech rule is formed of a proper noun including personal name information, a command, and a free text, or a pattern of a combination thereof. The speech-rule determination processor 114 compares the speech-recognition-result candidate of “Kenji san ni meeru” [“E-mail Mr. Kenji”] inputted from the speech recognizer 107 with one or more of the patterns of the speech rules stored in the speech-rule storage 115, and when the voice activation command of “san ni meeru” [“E-mail someone”] matched to the pattern is found, the speech-rule determination processor acquires information of “Proper Noun+Command+Free Text” as the speech rule of the input voice corresponding to that voice activation command. Then, the speech-rule determination processor 114 outputs the acquired information of the speech rule to the recognition-result unification processor 110 and to the state determination processor 111.

Then, in Step S105, upon receiving the first speech recognition result transmitted from the server 101, the receiver 109 outputs the first speech recognition result to the recognition-result unification processor 110.

Then, in Step S106, the recognition-result unification processor 110 confirms whether or not both of the client's speech recognition result and the server's speech recognition result are present. When both of them are present, the following processing is performed.

In Step S107, the recognition-result unification processor 110 then refers to the speech rule inputted from the speech-rule determination processor 114, to thereby judge whether or not the unification of the first speech recognition result by the speech recognition server 101 inputted from the receiver 109 and the second speech recognition result inputted from the speech recognizer 107 is allowable. Whether or not their unification is allowable is judged in such a manner that, when a command filled in a speech rule is commonly included in the first speech recognition result and the second speech recognition result, it is judged that their unification is allowable, and when no command is included in one of them, it is judged that their unification is not allowable. When the unification is allowable, processing moves to Step S108 by “Yes” branching, and when the unification is not allowable, processing moves to Step S110 by “No” branching.

Specifically, whether or not the unification is allowable is judged in the following manner. From the speech rule outputted by the speech-rule determination processor 114, the recognition-result unification processor 110 confirms that the command of “E-mail” is present in the character string. Then, the recognition-result unification processor searches the position corresponding to “E-mail” in the text of the server's speech recognition result and judges, when “E-mail” is not included in the text, that the unification is not allowable.

For example, when “E-mail” is inputted as a speech recognition result by the speech recognizer 107 and “meiru” [“feel down”] is inputted as a server's speech recognition result, the text of the server's speech recognition result is not matched to the speech rule inputted from the speech-rule determination processor 114 because “E-mail” is not included in the text. Thus, the recognition-result unification processor 110 judges that the unification is not allowable.

When determined that the unification is not allowable, the recognition-result unification processor 110 deems that it could not obtain any recognition result from the server. Thus, the recognition-result unification processor transmits the speech recognition result inputted from the speech recognizer 107 and information that it could not obtain the information from the server, to the state determination processor 111. For example, “E-mail” as a speech recognition result inputted from the speech recognizer 107, “Client's Speech Recognition Result: Present”, and “Server's Speech Recognition Result: Absent”, are transmitted to the state determination processor 111.

When determined that the unification is allowable, the recognition-result unification processor 110 specifies the position of the command in the next Step S108, as processing before the unification of the first speech recognition result by the speech recognition server 101 inputted from the receiver 109 and the second speech recognition result inputted from the speech recognizer 107. First, on the basis of the speech rule outputted by the speech-rule determination processor 114, the recognition-result unification processor confirms that the command of “E-mail” is present in the character string and then, searches “E-mail” in the text of the server's speech recognition result to thereby specify the position of “E-mail”. Then, based on “Proper Noun+Command+Free Text” as the speech rule, the recognition-result unification processor determines that a character string after the position of the command “E-mail” is a free text.

Then, in Step S109, the recognition-result unification processor 110 unifies the server's speech recognition result and the client's speech recognition result. First, for the speech rule, the recognition-result unification processor 110 adopts the proper noun and the command from the client's speech recognition result, and adopts the free text from the server's speech recognition result. Then, the processor applies the proper noun, the command and the free text to the respective speech elements in the speech rule. Here, the above processing is referred to as unification.

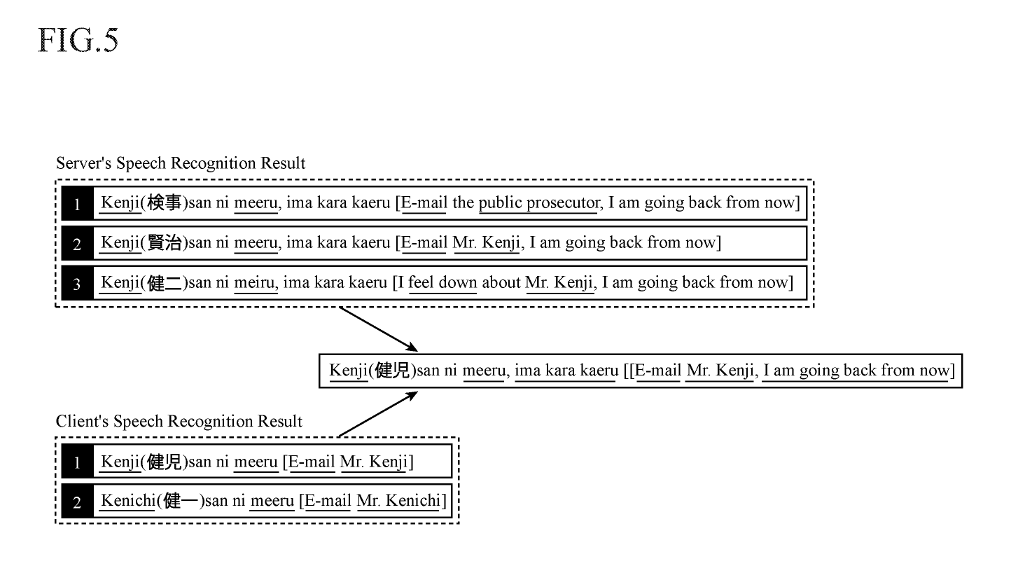

FIG. 5 is an illustration diagram illustrating the unification of the server's speech recognition result and the client's speech recognition result.

When the client's speech recognition result is “Kenji san ni meeru” [“E-mail Mr. Kenji”] and the server's speech recognition result is “Kenji san ni meiru, ima kara kaeru” [“E-mail the public prosecutor, I am going back from now”], the recognition-result unification processor 110 adopts from the client's speech recognition result, “Kenji” as the proper noun and “E-mail” as the command, and adopts “ima kara kaeru” [“I am going back from now”] as the free text from the server's speech recognition result. Then, the processor applies the thus-adopted character strings to the speech elements in the speech rule of Proper Noun, Command and Free Text, to thereby obtain a unified result of “E-mail Mr. Kenji, I am going back from now”.

Then, the recognition-result unification processor 110 outputs the unified result and information that both recognized results of the client and the server are obtained, to state determination processor 111. For example, the unified result “E-mail Mr. Kenji, I am going back from now”, “Client's Speech Recognition Result: Present”, and “Server's Speech Recognition Result: Present”, are transmitted to the state determination processor 111.

Then, in Step S110, the state determination processor 111 judges whether a speech recognition state can be determined, on the basis of the presence/absence of the client's speech recognition result and the presence/absence of the server's speech recognition result that are outputted by the recognition-result unification processor 110, and the speech rule.

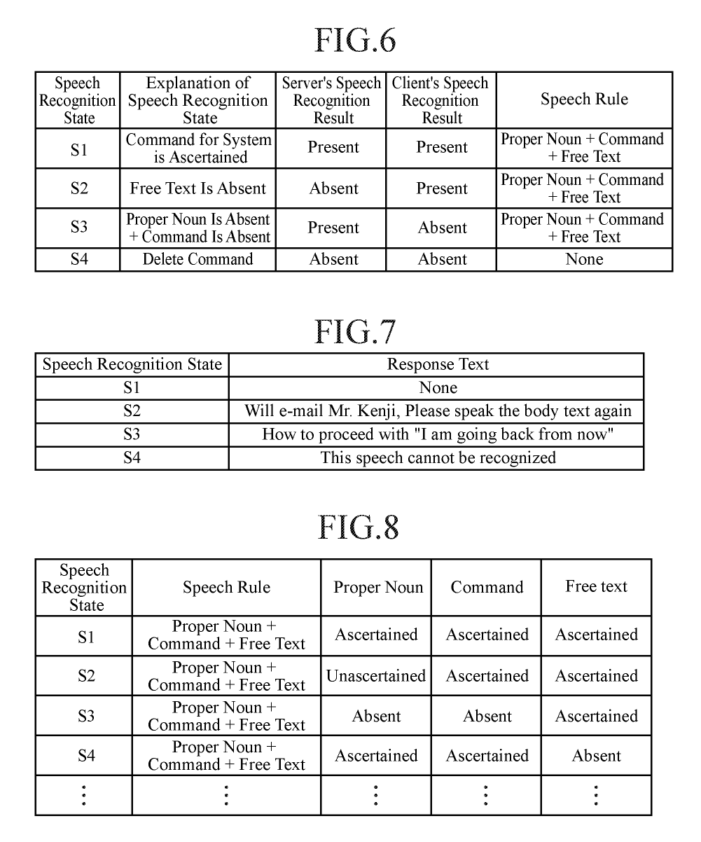

FIG. 6 is a diagram showing correspondence relationships among the speech recognition state, the presence/absence of the server's speech recognition result, the presence/absence of the client's speech recognition result and the speech rule.

The speech recognition state indicates whether or not a speech recognition result is obtained for the speech element in the speech rule. The state determination processor 111 is storing the correspondence relationships in which each speech recognition state is uniquely determined by the presence/absence of the server's speech recognition result, the presence/absence of the client's speech recognition result and the speech rule, by use of a correspondence table as shown in FIG. 6. In other words, the correspondences between the presence/absence of the server's speech recognition result and the presence/absence of each of the speech elements in the speech rule are predetermined, in such a manner that, when no speech recognition result is provided from the server and “Free Text” is included in the speech rule, it is determined that this meets the case of “No Free Text”. Therefore, it is possible to specify the speech element whose speech recognition result is not obtained, from the information of the presence/absence of each of the server's and client's speech recognition results.

For example, when received the information of “Speech Rule: Proper Noun+Command+Free Text”, “Client's Speech Recognition Result: Present” and “Server's Speech Recognition Result: Present”, the state determination processor 111 determines that the speech recognition state is S1, on the basis of the stored correspondence relationships. Note that in FIG. 6, the speech recognition state S4 corresponds to the situation that any speech recognition state could not be determined.

Then, in Step S111, the state determination processor 111 judges whether a command for the system can be ascertained or not. For example, when the speech recognition state is S1, the state determination processor ascertains the unified result “E-mail Mr. Kenji, I am going back from now” as the command for the system, and then moves processing to Step S112 by “Yes” branching.

Then, in Step S112, the state determination processor 111 outputs the command for the system “E-mail Mr. Kenji, I am going back from now” to that system.

Next, description will be made about operations in a case where the client's speech recognition result is provided but no speech recognition result is provided from the server.

In Step S106, when no speech recognition result is provided from the server, for example, when there is no response from the server for a specified time of T seconds, the receiver 109 transmits information indicative of absence of the server's speech recognition result, to the recognition-result unification processor 110.

The recognition-result unification processor 110 confirms whether both of the speech recognition result from the client and the speech recognition result from the server are present, and when the speech recognition result from the server is absent, it moves processing to Step S115 without performing the processing in Steps S107 to S109.

Then, in Step S115, the recognition-result unification processor 110 confirms whether or not the client's speech recognition result is present, and when the client's speech recognition result is present, it outputs the unified result to the state determination processor 111 and moves processing to Step S110 by “Yes” branching. Here, the speech recognition result from the server is absent, so that the unified result is given as the client's speech recognition result. For example, “Unified result: ‘E-mail Mr. Kenji’”, “Client's Speech Recognition Result: Present” and “Server's Speech Recognition Result: Absent”, are outputted to the state determination processor 111.

Then, in Step S110, the state determination processor 111 determines a speech recognition state using the information about the client's speech recognition result and the server's speech recognition result outputted by recognition-result unification processor 110, and the speech rule outputted by the speech-rule determination processor 114. Here, “Client's Speech Recognition State: Present”, “Server's Speech Recognition State: Absent” and “Speech Rule: Proper Noun+Command+Free Text” are given, so that, with reference to FIG. 6, it is determined that the speech recognition state is S2.

Then, in Step S111, the state determination processor 111 judges whether a command for the system can be ascertained or not. Specifically, the state determination processor 111 judges, when the speech recognition state is S1, that a command for the system is ascertained. Here, the speech recognition state obtained in Step S110 is S2, so that the state determination processor 111 judges that a command for the system is not ascertained, and outputs the speech recognition result S2 to the response text generator 112.

Further, the state determination processor 111, when a command for the system cannot be ascertained, outputs the speech recognition result S2 to the voice inputter 106, and then moves processing to Step S113 by “No” branching. This is for instructing the voice inputter 106 to transmit afterward voice data of the next input voice that is a free text, to the server.

Then, in Step S113, on the basis of the speech recognition state outputted by the state determination processor 111, the response text generator 112 generates a response text for prompting the user to respond.

FIG. 7 is a diagram showing a relationship between the speech recognition state and the response text to be generated.

The response text has a message for informing the user of the speech element whose speech recognition result is obtained, and prompting the user to speak about the speech element whose speech recognition result is not obtained. In the case of the speech recognition state S2, since the proper noun and the command are ascertained but there is no speech recognition result for a free text, a response text for prompting the user to speak only a free text, is outputted to the outputter 113. For example, as shown at S2 in FIG. 7, the response text generator 112 outputs a response text of “Will e-mail Mr. Kenji, Please speak the body text again” to the outputter 113.

In Step S114, the outputter 113 outputs through a display, a speaker and/or the like, the response text “Will e-mail Mr. Kenji, Please speak the body text again” outputted by the response text generator 112.

When the user re-speaks “I am going back from now” upon receiving the response text, the previously-described processing in Step S101 is performed. It should be noted that the voice inputter 106 has already received the speech recognition state S2 outputted by the state determination processor 111 and is thus aware that voice data coming next is of a free text. Thus, the voice inputter 106 outputs the voice data to the transmitter 108, but does not output it to the speech recognizer 107 of the client. Accordingly, the processing in Steps S103 and S104 is not performed.

The processing in Steps S201 to S203 in the sever is similar to that previously described, so that its description is omitted here.

In Step S105, the receiver 109 receives the speech recognition result transmitted from the server 101, and then outputs the speech recognition result to the recognition-result unification processor 110.

In Step S106, the recognition-result unification processor 110 determines that the speech recognition result from the server is present but the speech recognition result from the client is not present, and moves processing to Step S115 by “No” branching.

Then, in Step S115, because the client's speech recognition result is not present, the recognition-result unification processor 110 outputs the server's speech recognition result to the speech-rule determination processor 114, and moves processing to Step S116 by “No” branching.

Then, in Step S116, the speech-rule determination processor 114 determines the speech rule as previously described, and outputs the determined speech rule to the recognition-result unification processor 110. Then, the recognition-result unification processor 110 outputs “Server's Speech Recognition Result: Present” and “Unified Result: ‘I am going back from now’” to the state determination processor 111. Here, because of no client's speech recognition result, the server's speech recognition result is given as the unified result without change.

Then, in Step S110, the state determination processor 111 in which the speech recognition state before re-speaking is stored, updates the speech recognition state from the unified result outputted by the recognition-result unification processor 110 and the information of “Server's Speech Recognition Result: Present”. Addition of the information of “Server's Speech Recognition Result: Present” to the previous speech recognition state S2 results in that the client's speech recognition result and the server's speech recognition result are both present, so that the speech recognition state is updated from S2 to S1 with reference to FIG. 6. Then, the current unified result of “I am going back from now” is applied to the portion of the free text, so that “E-mail Mr. Kenji, I am going back from now” is ascertained as the command for the system.

Then, in Step S111, because the speech recognition state is S1, the state determination processor 111 determines that a command for the system can be ascertained, so that it is possible to output the command to the system.

Then, in Step S112, the state determination processor 111 transmits the command for the system “E-mail Mr. Kenji, I am going back from now” to that system.

It should be noted that, in Step S106, if the server's speech recognition result cannot be obtained in a specified time of T seconds even after the confirmation is repeated N times, because any substantial state cannot be determined in Step S110, the state determination processor 111 updates the speech recognition state from S2 to S4. The state determination processor 111 outputs the speech recognition state S4 to the response text generator 112, and deletes the speech recognition state and the unified result. The response text generator 112 refers to FIG. 7 to thereby generate a response text of “This speech cannot be recognized” corresponding to the speech recognition state S4 outputted by the recognition-result unification processor 110, and outputs the response text to the outputter 113.

Then, in Step S117, the outputter 113 makes notification of the response text. For example, it gives notification of “This speech cannot be recognized” to the user.

Next, description will be made about a case where the server's speech recognition result is provided but the client's speech recognition result is not provided.

Steps S101 to S104 and S201 to S203 are the same as those in the case where the client's speech recognition result is provided but the server's speech recognition result is not provided, so that their description is omitted here.

First, in Step S106, the recognition-result unification processor 110 confirms whether both of the client's speech recognition result and the server's speech recognition result are present. Here, the server's speech recognition result is present but the client's speech recognition result is not present, so that the recognition-result unification processor 110 does not perform unification processing.

Then, in Step S115, the recognition-result unification processor 110 confirms whether the client's speech recognition result is present. When the client's speech recognition result is not present, the recognition-result unification processor 110 outputs the server's speech recognition result to the speech-rule determination processor 114, and moves processing to Step S116 by “No” branching.

Then, in Step S116, the speech-rule determination processor 114 determines the speech rule for the server's speech recognition result. For example, for the result “Kenji san ni meiru, ima kara kaeru” [“I feel down about the public prosecutor, I am going back from now”], the speech-rule determination processor 114 checks whether the result has a portion matched to the voice activation command stored in the speech-rule storage 115 to thereby determine the speech rule. Instead, for the speech-recognition result list of the server, the speech-rule determination processor searches the voice activation command to check whether the list has a portion in which the voice activation command is highly likely to be included, to thereby determine the speech rule. Here, from the speech-recognition result list including “I feel down about the public prosecutor”, “E-mail the public prosecutor” and the like, the speech-rule determination processor 114 regards that they are highly likely to correspond the voice activation command “san ni meeru” [“E-mail someone”], to thereby determine that the speech rule is “Proper Noun+Command+Free Text”.

The speech-rule determination processor 114 outputs the determined speech rule to the recognition-result unification processor 110 and the state determination processor 111. The recognition-result unification processor 110 outputs “Client's Speech Recognition Result: Absent”, “Server's Speech Recognition Result: Present” and “Unified result: ‘I feel down about the public prosecutor, I am going back from now’” to the state determination processor 111. Here, because the client's speech recognition result is absent, the unified result is the server's speech recognition result itself.

Then, in Step S110, the state determination processor 111 judges whether a speech recognition state can be determined, on the basis of the speech rule outputted by the speech-rule determination processor 114, and the presence/absence of the client's speech recognition result, the presence/absence of the server's speech recognition result and the unified result that are outputted by the recognition-result unification processor 110. The state determination processor 111 refers to FIG. 6 to thereby determine the speech recognition state. Here, because the speech rule is “Proper Noun+Command+Free Text” and only the server's speech recognition result is present, the state determination processor 111 determines the speech recognition state to be S3 followed by storing this state.

Then, in Step S111, the state determination processor 111 judges whether a command for the system can be ascertained. Because the speech recognition state is not S1, the state determination processor 111 judges that a command for the system cannot be ascertained, to thereby determine a speech recognition state and outputs the determined speech recognition state to the response text generator 112. Further, the state determination processor 111 outputs the determined speech recognition state to the voice inputter 106. This is for causing the next input voice to be outputted to the speech recognizer 107 of the client without being transmitted to the server.

Then, in Step S113, with respect to the thus-obtained speech recognition state, the response text generator 112 refers to FIG. 7 to thereby generate a response text. Then, the response text generator 112 outputs the response text to the outputter 113. For example, when the speech recognition state is S3, it generates a response text of “How to proceed with ‘I am going back from now’”, and outputs the response text to the outputter 113.

Then, in Step S114, the outputter 113 outputs the response text through the display, the speaker and/or the like, to thereby prompt the user to re-speak the speech element whose recognition result is not obtained.

After prompting the user to re-speak, when the user re-speaks “E-mail Mr. Kenji”, because the processing in S101 to S104 is performed as previously described, its description is omitted here. Note that, according to the speech recognition state outputted by the state determination processor 111, the voice inputter 106 has determined where the re-spoken voice is to be transmitted. In the case of S2, the voice inputter outputs the voice data to only the transmitter 108 in order that the data is to be transmitted to the server, and in the case of S3, the voice inputter outputs the voice data to the speech recognizer 107 of the client.

Then, in Step S106, the recognition-result unification processor 110 receives the client's speech recognition result and the determination result of the speech rule outputted by the speech-rule determination processor 114, and confirms whether both of the client's speech recognition result and the server's speech recognition result are present.

Then, in Step S115, the recognition-result unification processor 110 confirms whether the client's speech recognition result is present, and when present, outputs “Client's Speech Recognition Result: Present”, “Server's Speech Recognition Result: Absent” and “Unified Result: ‘E-mail Mr. Kenji’” to the state determination processor 111. Here, because the server's speech recognition result is absent, the recognition-result unification processor 110 regards the client's speech recognition result as the unified result.

Then, in Step S110, the state determination processor 111 updates the speech recognition state from the stored speech recognition state before re-speaking, and the information about the client's speech recognition result, the server's speech recognition result and the unified result outputted by the recognition-result unification processor 110. The speech recognition state before re-speaking was S3, and the client's speech recognition result was absent. However, because of the re-speaking, the client's speech recognition result becomes “Present”, so that the state determination processor 111 updates the speech recognition state from S3 to S1. Further, the state determination processor applies the unified result “E-mail Mr. Kenji” outputted by the recognition-result unification processor 110, to the speech elements of “Proper Noun+Command” in the stored speech rule, to thereby ascertain a command for the system of “E-mail Mr. Kenji, I am going back from now”.

The following Steps S111 to S112 are similar to those previously described, so that their description is omitted here.

As described above, according to Embodiment 1 of the invention, the correspondence relationships among the presence/absence of the server's speech recognition result, the presence/absence of the client's speech recognition result and each of the speech elements in the speech rule has been determined and the correspondence relationships are being stored. Thus, even when no speech recognition result is provided from one of the server and the client, it is possible to specify the part whose recognition result is not obtained, from the speech rule and the correspondence relationship, to thereby prompt the user to re-speak that part. As a result, there is an effect such that it is not necessary to prompt the user to re-speak from the beginning, so that the burden on the user can be reduced.

When no speech recognition result is provided from the client, it has been assumed that the response text generator 112 generates the response text “How to proceed with ‘I am going back from now’”; however, it is allowable that, in the following manner, the state determination processor 111 analyzes the free text whose recognition result is obtained to thereby perform command estimation, and then causes the user to select one of the estimated command candidates. With respect to the free text, the state determination processor 111 searches any sentence included therein that has a high degree of affinity for each of pre-registered commands, and determines command candidates in descending order of degrees of affinity. The degree of affinity is defined, for example, after accumulation of examples of past speech texts, by the co-occurrence probability of the command emerging in the examples and each of the words in the free text therein. When the sentence is “I am going back from now”, it is assumed to be high in the degree of affinity for “mail” or “telephone”, so that a corresponding candidate is outputted through the display or the speaker. Further, it is conceivable to notify the user of “1: Mail, 2: Telephone—which one do you select?” or the like, to thereby cause the user to speak “1”. The selection may be made by way of a number, or in such a way that the user re-speaks “mail” or “telephone”. This further reduces the burden on the user for re-speaking.

Further, when no speech recognition result is provided from the server, it has been assumed that the response text generator 112 generates the response text “Will e-mail Mr. Kenji, Please speak the body text again”; however, it may instead generate a response text of “Do you want to e-mail Mr. Kenji?”. After the outputter 113 outputs the response text through the display or the speaker, the speech recognition state may be determined in the state determination processor 111 after it receiving the result of “Yes” by the user.

Note that, when the user speaks “No”, the state determination processor 111 judges that the speech recognition state could not be determined, and thus outputs the speech recognition state S4 to the response text generator 112. Thereafter, as shown by Step S117, the state determination processor notifies the user that the speech could not be recognized, through the outputter 113. In this manner, by inquiring to the user whether the speech elements corresponding to “Proper Noun+Command” can be ascertained, it is possible to reduce recognition errors in the proper noun and the command.

### Embodiment 2

Next, a speech recognition device according to Embodiment 2 will be described. In Embodiment 1, the description has been made about the case where one of the server's and client's speech recognition results is absent. In Embodiment 2, description will be made about a case where although one of the server's and client's speech recognition results is present, there is ambiguity in the speech recognition result, so that a part of the speech recognition result is not ascertained.

The configuration of the speech recognition device according to Embodiment 2 is the same as that of Embodiment 1 shown in FIG. 1, so that the description of its respective parts is omitted here.

Next, operations will be described.

When the speech recognizer 107 performs speech recognition on the voice data provided when the user speaks “E-mail Mr. Kenji”, such a case possibly arises depending on the speaking situation, where plural speech-recognition-result candidates such as “E-mail Mr. Kenji” and “E-mail Mr. Kenichi” are listed, and the plural speech-recognition-result candidates have their respective recognition scores that are close to each other. When there are such plural speech-recognition-result candidates, the recognition-result unification processor 110 generates “E-mail Mr.??”, for example, as a result from the speech recognition, in order to inquire to the user about the ambiguous proper noun part.

The recognition-result unification processor 110 outputs “Server's Speech Recognition Result: Present”, “Client's Speech Recognition Result: Present” and “Unified Result: ‘E-mail Mr.??, I am going back from now’” to the state determination processor 111.

From the speech rule and the unified result, the state determination processor 111 judges which one of the speech elements in the speech rule is ascertained. Then, the state determination processor 111 determines a speech recognition state on the basis of whether each of the speech elements in the speech rule is ascertained or unascertained, or whether there is no speech element.

FIG. 8 is a diagram showing a correspondence relationship between a state of the speech elements in the speech rule and a speech recognition state. For example, in the case of “E-mail Mr.??, I am going back from now”, because the proper noun part is unascertained but the command and the free text are ascertained, the speech recognition state is determined as S2. The state determination processor 111 outputs the speech recognition state S2 to the response text generator 112.

In response to the speech recognition state S2, the response text generator 112 generates a response text of “Who do you want to E-mail?” for prompting the user to re-speak the proper noun, and outputs the response text to the outputter 113. As a method for prompting the user to re-speak, choices may be indicated based on the list of the client's speech recognition results. For example, such a configuration is conceivable that notifies the user of “1: Mr. Kenji, 2: Mr. Kenichi, 3: Mr. Kengo—who do you want to e-mail?” or the like, to thereby cause him/her to speak one of the numbers. When the recognition score becomes a reliable score by receiving re-spoken content of the user, “Mr. Kenji” is ascertained, and then, in combination of the voice activation command, the text of “E-mail Mr. Kenji” is ascertained and this speech recognition result is outputted.

As described above, according to the invention of Embodiment 2, there is an effect such that, even when the speech recognition result from the server or the client is present but a part in that speech recognition result is not ascertained, it is unnecessary for the user to re-speak completely, so that the burden on the user is reduced.

### REFERENCE SIGNS LIST

101: speech recognition server, 102: speech recognition device of the client, 103: receiver of the server, 104: speech recognizer of the server, 105: transmitter of the server, 106: voice inputter, 107: speech recognizer of the client, 108: transmitter of the client, 109: receiver of the client, 110: recognition-result unification processor, 111: state determination processor, 112: response text generator, 113: outputter, 114: speech-rule determination processor, 115: speech-rule storage.

1. A speech recognition device comprising:
a transmitter that transmits an input voice to a server;
a receiver that receives a first speech recognition result that is a result from speech recognition by the server on the input voice transmitted by the transmitter;
a speech recognizer that performs speech recognition on the input voice to thereby obtain a second speech recognition result;
a speech-rule storage in which speech rules each representing a formation of speech elements for the input voice are stored;
a speech-rule determination processor that refers to one or more of the speech rules to thereby determine the speech rule matched to the second speech recognition result;
a state determination processor that is storing correspondence relationships among presence/absence of the first speech recognition result, presence/absence of the second speech recognition result and presence/absence of the speech element that forms the speech rule, and that determines from the correspondence relationships, a speech recognition state indicating at least one of the speech elements whose speech recognition result is not obtained;
a response text generator that generates according to the speech recognition state determined by the state determination processor, a response text for inquiring about at least the one of the speech elements whose speech recognition result is not obtained; and
an outputter that outputs the response text.

2. The speech recognition device of claim 1, further comprising a recognition result unification processor that outputs a unified result from unification of the first speech recognition result and the second speech recognition result using the speech rule,
wherein the state determination processor determines the speech recognition state for the unified result.

3. The speech recognition device of claim 1, wherein the speech rule includes a proper noun, a command and a free text.

4. The speech recognition device of claim 3, wherein the receiver receives the first speech recognition result from speech recognition on the free text by the server; and
wherein the state determination processor performs estimation of the command for the first speech recognition result, to thereby determine the speech recognition state.

5. The speech recognition device of claim 1, wherein the speech recognizer outputs plural second speech recognition results each being said second speech recognition result; and
wherein the response text generator generates the response text for causing a user to select one of the plural second speech recognition results.

6. A speech recognition method for a speech recognition device which comprises a transmitter, a receiver, a speech recognizer, a speech-rule determination processor, a state determination processor, a response text generator and an outputter, and in which speech rules each representing a formation of speech elements are stored in a memory, said speech recognition method comprising:
a transmission step in which the transmitter transmits an input voice to a server;
a reception step in which the receiver receives a first speech recognition result that is a result from speech recognition by the server on the input voice transmitted in the transmission step;
a speech recognition step in which the speech recognizer performs speech recognition on the input voice to thereby obtain a second speech recognition result;
a speech-rule determination step in which the speech-rule determination processor refers to one or more of the speech rules to thereby determine the speech rule matched to the second speech recognition result;
a state determination step in which the state determination processor is storing correspondence relationships among presence/absence of the first speech recognition result, presence/absence of the second speech recognition result and presence/absence of the speech element that forms the speech rule, and determines from the correspondence relationships, a speech recognition state indicating at least one of the speech elements whose speech recognition result is not obtained;
a response text generation step in which the response text generator generates according to the speech recognition state determined in the state determination step, a response text for inquiring about said at least one of the speech elements whose speech recognition result is not obtained; and
a step in which the outputter outputs the response text.
